(19) United States
(12) Patent Application Publication
(10) Pub. No.: US 2009/0242231 A1
(43) Pub. Date: Oct. 1, 2009

(54) SILVER NANOWIRE, PRODUCTION METHOD THEREOF, AND AQUEOUS DISPERSION

(75) Inventors: Nori Miyagisima, Kanagawa (JP); Kenzi Naoi, Kanagawa (JP); Hiroyuki Hirai, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/412,695

(22) Filed: Mar. 27, 2009

(30) Foreign Application Priority Data
Mar. 31, 2008 (JP) 2008-091702

(51) Int. Cl. H02G 3/04; C22B 11/00; H01B 1/22; C22C 5/06; H01B 1/02

(52) U.S. Cl. 174/68.1; 75/711; 252/514; 420/501; 428/606; 977/762; 977/900

(57) ABSTRACT

A method for producing a silver nanowire including heating a silver complex in a water solvent at a temperature equal to or below the boiling point of the water solvent, and the silver nanowire produced by the method.

### BACKGROUND OF THE INVENTION

1. Field of the Invention

The present invention relates to a silver nanowire having both transparency and conductivity, a method for producing a silver nanowire in an aqueous solvent at a temperature equal to or below the boiling point of the solvent, and an aqueous dispersion.

2. Description of the Related Art

To produce an aqueous dispersion of metallic nanowires having a long axis of 1 μm or more and a short axis of 100 nm or less, some methods are proposed in which a silver nanowire-polyol dispersion obtained through a polyol method is subjected to centrifugal separation and subsequent solvent replacement to obtain an aqueous dispersion (US Patent Application Publication Nos. 2005/0056118 and 2007/0074316).

Meanwhile, as a method of synthesizing silver nanowires using an aqueous solvent, there is proposed a method which utilizes ammonia silver to synthesize nanowires having a long axis of several ten micrometers and a short axis of 28 nm in an autoclave at 120° C. for 8 hours (J. Phys. Chem. B 2005, 109, 5497).

As a method of synthesizing silver nanowires using an aqueous solvent at 100° C. or less instead of ammonium, there is proposed a method for synthesizing silver nanowires having a long axis of several ten micrometers to 100 μm and a short axis of 80 nm for overnight or more in an aqueous solvent at 45° C. (Adv. Funct. Mater. 2004, 14, 183).

Another method for producing silver nanowires is proposed in which silver nanowires having a long axis of 300 nm to 4 μm and a short axis of 15 nm is produced in a 100° C. aqueous solvent (J. Solid State Chemistry 179 (2006) 696).

Another method for producing silver nanowires is proposed in which silver nanowires having a short axis of 90 nm to 300 nm is produced through immersing a glass substrate on which cupper fine particles are formed by an electric deposition into an aqueous solution of silver nitrate overnight (Japanese Patent Application Laid Open (JP-A) No. 2006-196923).

Although methods of producing silver nanowires have been proposed by these documents, there still has been a demand for producing nanowires efficiently, and cost effectively in a short time using an aqueous solvent without pressurization by an autoclave. Moreover, a prevention of oxidation is desired in the case of silver nanowires having a small short axis, and transparency is desired in the case of silver nanowires having a large short axis.

Thus there is still a demand for silver nanowires having a short axis of 5 nm to 500 nm, which can satisfy all the above conditions.

### BRIEF SUMMARY OF THE INVENTION

The present invention relates to silver nanowires having both transparency and conductivity, a method for producing silver nanowires in an aqueous solvent at a temperature equal to or below the boiling point of the solvent, and an aqueous dispersion containing the silver nanowires, the dispersion being excellent in storage stability after coating and dispersion stability.

The above problems are solved by the following means;
<1> A method for producing a silver nanowire including heating a silver complex in an aqueous solvent at a temperature equal to or below the boiling point of the aqueous solvent.
<2> The method for producing a silver nanowire according to <1>, wherein the silver complex is a complex of ammonical silver.
<3> The method for producing a silver nanowire according to <1>, wherein the silver nanowire is produced through a silver halide.
<4> The method for producing a silver nanowire according to <1>, wherein a reducing agent is added when heating the silver complex.
<5> The method for producing a silver nanowire according to <1>, wherein the reducing agent is a reducing sugar.
<6> A silver nanowire obtainable by a method for producing a silver nanowire, wherein the method includes heating a silver complex in a water solvent at a temperature equal to or below the boiling point of the water solvent.
<7> The silver nanowire according to <6>, having a short axis of 5 nm to 500 nm in length.
<8> An aqueous dispersion containing:

a silver nanowire,

wherein the silver nanowire is obtainable by a method for producing a silver nanowire, and wherein the method includes heating a silver complex in a water solvent at a temperature equal to or below the boiling point of the water solvent.
<9> A transparent conductor including:

a transparent conductive layer,

wherein the transparent conductive layer is formed with an aqueous dispersion containing a silver nanowire, and

wherein the silver nanowire is obtainable by a method for producing a silver nanowire, and the method includes heating a silver complex in a water solvent at a temperature equal to or below the boiling point of the water solvent.

The present invention can solve conventional problems, and provide silver nanowires having both transparency and conductivity, a method for producing silver nanowires in an aqueous solvent at a temperature equal to or below the boiling point of the solvent, and an aqueous dispersion containing the silver nanowires, the dispersion being excellent in storage stability after coating and dispersion stability.

### DETAILED DESCRIPTION OF THE INVENTION

### (Method for Producing Silver Nanowires and the Silver Nanowires)

The method for producing silver nanowires according to the present invention is characterized by heating a silver complex in aqueous solvent at a temperature equal to or below the boiling point of the aqueous solvent.

The silver nanowires of the present invention are produced by the method for producing silver nanowires of the present invention.

Hereinafter, the production method of the silver nanowires of the present invention, along with the silver nanowires themselves, will be explained in detail.

In the present invention, a silver complex is heated in an aqueous solvent at a temperature equal to or below the boiling point of the aqueous solvent, and through a reduction reaction thereof, silver nanowires are produced. Thereafter, if necessary, a desalting process may be inserted, which is in some uses preferable in order to increase the conductivity of the aqueous dispersion.

The above-mentioned aqueous solvent preferably contains 20% or more of water. The solvent other than water is preferably a hydrophilic solvent. Examples of the hydrophilic solvent include alcohols such as methanol, ethanol, propanol, isopropanol, and butanol; ethers such as dioxane and tetrahydrofuran; ketones such as aceton; and cyclic ethers such as tetrahydrofuran and dioxane.

The heating temperature is equal to or below the boiling point of the aqueous solvent, preferably under 100° C. or lower, more preferably 20° C. to 100° C., more preferably 30° C. to 100° C., even more preferably 40° C. to 100° C.

If the heating temperature is higher than 100° C., transmittance of the coated film is low because it appears that a dispersant that strongly adsorbs to the particles is reduced. If the heating temperature is too low, dispersion stability of silver nanowires degrades because a core formation probability is lowered and a silver nanowire becomes too long, and so silver nanowires easily gets entangled. This tendency is especially remarkable at 20° C. or lower.

The reaction for producing silver nanowires is preferably performed under atmospheric pressure without additional pressure. Although the reaction may be performed with or without stirring, it is preferable to perform it with stirring.

The silver complex is not particularly limited, and can be selected appropriately according to the purpose of use. Preferable ligands for the silver complex include CN⁻, SCN⁻, SO₃²⁻, thiourea, and ammonia. Detailed information thereon can be found in “The theory of the photographic process, 4^{th} edition, Macmillan publishing, T. H. James.” Of the silver complexes, a silver ammonia complex is more preferable.

In the above heating process, it is preferable to use a reducing agent. The reducing agent is not particularly limited, and can be selected from those commonly used. Examples of the reducing agent include metal borohydride salts such as sodium borohydride, and potassium borohydride; aluminium hydride salts such as lithium aluminium hydride, potassium aluminium hydride, cesium aluminium hydride, berylium aluminium hydride, magnesium aluminium hydride, and calcium aluminium hydride; sodium sulfite, hydrazine compounds, dextrin, hydroquinone, hydroxylamine, citric acid and a salt thereof, succinic acid and a salt thereof, and ascorbic acid and a salt thereof, alkanol amines such as diethylaminoethanol, ethanolamine, propanolamine, triethanolamine, and dimethylaminopropanol; aliphatic amines such as propyl amine, butyl amine, dipropylene amine, ethylene diamine, and triethylene pentamine; heterocyclic amines such as piperidine, pyrrolidine, N-methyl pyrrolidine, and morpholine; aromatic amines such as aniline, N-methyl aniline, toluidine, anisidine, and phenetidine; aralkyl amines such as benzyl amine, xylene diamine, and N-methylbenzyl amine; alcohols such as methanol, ethanol, and 2-propanol; ethyleneglycol, glutathione, organic acids (e.g., citric acid, malic acid, and tartaric acid), reducing sugars (e.g., glucose, galactose, mannose, fructose, sucrose, maltose, raffinose, and stachyose), and sugar alcohols (e.g., sorbitol). Of these, reducing sugars, and sugar alcohols as derivatives of reducing sugars are more preferable.

Some of the reducing agents can also play as a dispersant, which are preferably used.

The time of incorporating the reducing agent may be before or after the addition of the dispersant, and may be before or after the addition of the halogen compound or the silver halide fine particles.

When the silver nanowires of the present invention are produced, it is preferable to add a dispersant and a halogen compound, or silver halide fine particles. The shape of the nanowire can be controlled by changing the amount of the dispersant, the halogen compound or the silver halide fine particles.

The dispersant may be added before the preparation of the particles in the presence of a dispersion polymer, or may be added to control the dispersion state after the preparation of the particles. However, it is preferable to add it before the preparation of the particles.

Examples of the dispersant include an amino group-containing compound, a thiol group-containing compound, a sulfide group-containing compound, an amino acid or a derivative thereof, a peptide compound, a polysaccharide, a polysaccharide-derived natural polymer, a synthetic polymer, and a polymer such as a gel derived therefrom.

Examples of the polymer include a polymer capable of protecting colloids such as gelatin, polyvinylalcohol (P-3), methyl cellulose, hydrocypropylcellulose, polyalkyleneamine, a partial alkyl ester of polyacrylic acid, polyvinylpyrrolidone (P-1), and a polyvinylpyrrolidone copolymer.

As for the structures usable as the dispersant, “A cyclopaedia of pigments,” edited by Seishiro Ito, Kabushiki Kaisha Asakura Shoten, 2000 can be referred to.

The shape of the nanowire can be varied according to the type of the dispersant used.

The halogen compound is not particularly limited so long as it contains bromine, chlorine or iodine, and can be selected according to the purpose of use. Examples of the halogen compound include alkali halides such as sodium bromide, sodium chloride, sodium iodide, potassium iodide, potassium bromide, potassium chloride; or a substance usable in combination with the dispersant shown below. The addition timing of the halogen compound may be before or after the addition of the dispersant, or before or after the reducing agent. A part of the halogen compound can form a silver halide fine particle.

Some types of the halogen compounds can function as a dispersant, which are also preferably used.

A silver halide fine particle may be used instead of the halogen compound, or in combination with the halogen compound.

The dispersant and the halogen compound or silver halide fine particle may be the same substance. Examples of the compound serving as both dispersant and halogen compound include HTAB (hexadecyl-trimethylammonium bromide) which has an amino group and a bromide ion, and HTAC (hexadecyl-trimethylammonium chloride) which has an amino group and a chloride ion.

The above-mentioned desalting process can be carried out after the formation of silver nanowires, through ultrafiltration, dialysis, gel filtration, decantation, centrifugation, or the like.

### —Silver Nanowires—

Shape of the silver nanowire is not particularly limited and may be appropriately selected according to the purpose of use. For example, it may have a shape such as a cylinder, a rectangle, or a cylinder having a polygonal cross section.

The length of the long axis of the silver nanowire is preferably 1 μm to 500 μm, more preferably 5 μm to 250 μm, even more preferably 10 μm to 100 μm.

The length of the short axis of the silver nanowire is preferably 5 nm to 500 nm, more preferably 10 nm to 100 nm, even more preferably 10 nm to 50 nm.

If the length of the long axis is less than 1 μm, in the conductor produced by coating, contact points between the metals are poor, so that the conductor is less conductive and the electrical resistance is high. If the length of the long axis is greater than 500 μm, the silver nanowires easily tangle with each other, and so the dispersion stability can degrade.

If the length of the short axis is greater than 500 nm, though the performance as a conductor may be good, a problem arises that the occurrence of haze due to light scattering is so remarkable that the transparency degrades. If the length of the short axis is less than 5 nm, though the transparency may be good, a problem arises that conductivity degrades by the oxidation.

Here, the lengths of the long axis and short axis can be determined by, for example, observing TEM images obtained using a transmission electron microscope (TEM).

### (Aqueous Dispersion)

The aqueous dispersion of the present invention contains the silver nanowires of the present invention in a dispersion medium.

The amount of the silver nanowires in the aqueous dispersion is preferably 0.1% by mass to 99% by mass, more preferably 0.3% by mass to 95% by mass. If the amount is less than 0.1% by mass, the load in production and drying processes is extremely large. If the amount exceeds 99% by mass, the particles tends to aggregate.

It is preferable to contain the silver nanowires having a long axis of 10 μm or more in length in an amount 0.01% by mass or more, more preferably 0.05% by mass or more, in view that the conductivity can be increased even by the use of lower coating amount of silver, which is an amount not impairing the transparency.

The dispersion medium of the aqueous dispersion of the present invention mainly contains water, and may additionally contain an organic solvent compatible with water in a ratio of 80% by volume or less.

The organic solvent is preferably an alcohol-based compound having the boiling point of 50° C. to 250° C., more preferably 55° C. to 200° C. A combined use of water and an alcohol-based compound can bring about an improved coating performance in the coating process and a reduction of drying load.

The alcohol-based compound is not particularly limited, and can be selected properly according to the purpose of use. Examples thereof include methanol, ethanol, ethylene glycol, diethylene glycol, triethylene glycol, polyethylene glycol 200, polyethylene glycol 300, glycerine, propylene glycol, dipropylene glycol, 1,3-propane diol, 1,2-butane diol, 1,4-butane diol, 1,5-pentane diol, 1-ethoxy-2-propanol, ethanolamine, diethanolamine, 2-(2-aminoethoxy)ethanol, and 2-dimethylaminoisopropanol. These compounds may be used solely or in combination of two or more. Of these, ethanol and ethylene glycol are more preferable.

The aqueous dispersion of the present invention is preferably, if possible, free from any inorganic ion such as alkali metal ion, alkaline earth metal ion, or halide ion.

The electric conductivity of the aqueous dispersion is preferably 1 mS/cm or less, more preferably 0.1 mS/cm or less, even more preferably 0.05 mS/cm or less.

The viscosity of the aqueous dispersion at 20° C. is preferably 0.5 mPa·s to 100 mPa·s, more preferably 1 mPa·s to 50 mPa·s.

The aqueous dispersion of the present invention may contain, if necessary, various additives such as a surfactant, a polymerizable compound, an antioxidant, an antisulfurization agent, a corrosion inhibitor, a viscosity modifier, and an antiseptic.

The corrosion inhibitor is not particularly limited and can be selected properly according to the purpose of use. Preferable for the corrosion inhibitor is an azole compound. The azole compound may be, for example, at least one selected from the group consisting of benzotriazole, tolyltriazole, mercaptobenzothiazole, mercaptobenzotriazole, mercaptobenzotetrazole, (2-benzothiazolylthio)acetic acid, 3-(2-benzothiazolylthio)propionic acid, an alkali metal salt thereof, an ammonium salt thereof, and an amine salt thereof. The presence of the corrosion inhibitor ensures markedly excellent anti-rust effect. The corrosion inhibitor can be applied by directly adding to the aqueous dispersion; by adding in the state of solution suitable for dissolving the corrosion inhibitor; by adding in the state of its powder; or by immersing a transparent conductor produced as described later into a bath containing the corrosion inhibitor.

The aqueous dispersion of the present invention may be used as an aqueous ink for an inkjet printer or a dispenser.

In the image formation by using an inkjet printer, a substrate on which the aqueous dispersion is formed is exemplified by a paper, a coated paper, and a PET film whose surface is coated with a hydrophilic polymer.

### (Transparent Conductor)

The transparent conductor of the present invention has a transparent conductive layer formed by the aqueous dispersion of the present invention. In order to produce the transparent conductor, the aqueous dispersion of the present invention is coated onto the substrate and the coated substrate is then dried.

Hereinafter, the transparent conductor of the present invention is explained in detail through describing a method for producing the transparent conductor.

The substrate on which the aqueous dispersion is coated is not particular limited and can be selected properly according to the purpose of use. Examples of the substrates for the transparent conductor include the following materials. Of these, a polymer film is preferable in terms of production suitability, lightness, flexibility, and optical properties (polarization). More preferable are PET, TAC and PEN films.

(1) Glass such as quartz glass, non-alkali glass, crystallized transparent glass, PYREX (a registered trade mark) glass, and supphire.

(2) An acryl resin such as polycarbonate and polymethacrylate; a vinyl chloride resin such as polyvinyl chloride and vinyl chloride copolymer; a thermoplastic resin such as polyarylate, polysulfone, polyethersulfone, polyimide, PET, PEN, fluorocarbon resin, phenoxy resin, polyolefin resin, nylon, styrene resin, and ABS resin.

(3) A thermosetting resin such as epoxy resin.

The above substrate materials may be used in combination, if desired. Properly selected from the above-recited substrate materials, the substrate can be formed as a flexible substrate such as film or as a rigid substrate.

The shape of the substrate may be any of disk, card, or sheet. The substrate may be laminated three-dimensionally. The substrate may have fine pores or fine groove on the surface where the circuit is to be printed. Onto the fine pores or fine grooves, the aqueous dispersion of the present invention may be ejected by an inkjet printer or a dispenser.

It is preferable for the surface of the substrate to be hydrophilic. Specifically, it is preferable for the surface of the substrate to be coated with a hydrophilic polymer. With such a hydrophilication treatment, the coating property and/or adhesiveness of the aqueous dispersion onto the substrate are improved.

The hydrophilication treatment is not particularly limited and can be selected properly according to the purpose. Examples thereof include chemical treatment, mechanical surface roughening treatment, corona discharge treatment, flame treatment, ultraviolet treatment, glow discharge treatment, active plasma treatment, and laser treatment. It is preferable to control the surface tension of the surface to 30 dyne/cm or more by any of the hydrophilication treatments.

The hydrophilic polymer to be coated on the surface of the substrate is not particularly limited, and can be selected properly according to the purpose of use. Examples thereof include gelatin, gelatin derivative, casein, agar, starch, polyvinylalcohol, polyacrylic acid copolymer, carboxymethylcellulose, hydroxyethylcellulose, polyvinylpyrrolidone, and dextran.

The thickness of the hydrophilic polymer layer (after dried) is preferably 0.001 μm to 100 μm, more preferably 0.01 μm to 20 μm.

It is preferable to incorporate a hardening agent into the hydrophilic polymer layer to enhance the film strength. The hardening agent is not particularly limited and can be selected properly according to the purpose of use. Examples thereof include aldehyde compounds such as formaldehyde and glutaric aldehyde; ketone compounds such as diacetyl and cyclopentanedion; vinyl sulfone compounds such as divinylsulfone; triazine compounds such as 2-hydroxy-4,6-dichloro-1,3,5-triazine; isocyanate compounds such as the compound disclosed in the U.S. Pat. No. 3,103,437.

The hydrophilic polymer layer can be formed through a process in which the above compound is dissolved or dispersed in any proper solvent such as water to prepare a coating liquid, and then the liquid is coated on the hydrophilicated surface of the substrate by any of coating methods such as spin coating, dip coating, extrusion coating, bar coating, and die coating. It is preferable to introduce an undercoat layer between the substrate and the hydrophilic polymer layer in order to further improve the adhesiveness. The temperature for the drying is preferably 120° C. or less, more preferably 30° C. to 100° C., even more preferably 40° C. to 100° C.

In the present invention, after preparing a transparent conductor, it is preferable to let the prepared conductor go through a corrosion inhibitor bath to thereby obtain more excellent corrosion inhibiting effect.

### —Use—

The transparent conductor of the present invention has broad uses, including a touch panel, an antistatic treatment for a display, an electromagnetic interference sealed material, an electrode or antistatic agent for an organic or inorganic EL display, an electrode for a solar cell, and electronic paper.

### EXAMPLES

Next, the Examples of the present invention are described. These Examples, however, should not be construed as limiting the present invention.

In the Examples and Comparative Examples shown below, “the average particle diameter (lengths of the long axis and short axis) of the silver nanowire” and “the viscosity of water dispersion” were measured in the following manner.

### <Average Particle Diameter (the Length of the Long Axis and the Short Axis) of the Silver Nanowires>

The average particle diameter of the silver nanowires was measured by observing the TEM images using a transmission electron microscope (TEM; JEM-2000FX, produced by JEOL Ltd.).

### <Viscosity of the Aqueous Dispersion>

The viscosity at 25° C. was measured with VISCOMATE VM-1G (produced by CBC Co., Ltd.).

### Example 1

### —Preparation of Additive Liquid A—

0.51 g of silver nitrate powder was dissolved in 50 mL of pure water. Then 1N aqueous ammonia solution was added to the resultant solution such that the mixed solution is transparent. Pure water was further added to adjust the whole volume of the solution to 100 mL.

—Preparation of Additive liquid G—

0.5 g of glucose powder was dissolved in 140 mL of pure water to prepare Additive liquid G.

### —Preparation of Additive Liquid H—

0.5 g of HTAB (hexadecyl-trimethylammonium bromide) powder was dissolved in 27.5 mL of pure water to obtain Additive liquid H.

### —Preparation of Sample 101—

20.6 mL of Additive liquid A was placed in a three-neck flask and stirred at room temperature. To this liquid, 41 mL of pure water, 16.5 mL of Additive liquid H, and 20.6 mL of Additive liquid G were added with a funnel, and the mixture was then heated for 5 hours at 90° C. The temperature of the sample liquid in the three-neck flask during heating was 77° C. under atmospheric pressure. The number of revolutions for stirring was 200 rpm.

The resultant aqueous dispersion was cooled, centrifuged, and purified until the conductivity became 50 μS/cm or less, to thereby yield the target aqueous dispersion.

The silver nanowires in the obtained Sample 101 had a short axis whose length was 15 nm to 30 nm and a long axis whose length was 40 μm to 60 μm.

### —Preparation of Sample 102—

Sample 102 was prepared by replacing glucose of Additive liquid G in the aqueous dispersion of Sample 101 with equimolar maltose.

The silver nanowires in the obtained Sample 102 had a short axis whose length was 30 nm to 40 nm and a long axis whose length was 30 μm to 50 μm.

### —Preparation of Sample 103—

Sample 103 was prepared by replacing HTAB of Additive liquid H in the aqueous dispersion of Sample 101 with 40% by mass PVP (K30) and equimolar NaBr.

The silver nanowires in the obtained Sample 103 had a short axis whose length was 15 nm to 40 nm and a long axis whose length was 30 μm to 60 μm.

### —Preparation of Sample 104—

Sample 104 was prepared by replacing silver nitrate of Additive liquid A in the aqueous dispersion of Sample 101 with equimolar silver acetate.

The silver nanowires in the obtained Sample 104 had a short axis whose length was 15 nm to 25 nm and a long axis whose length was 40 μm to 60 μm.

### —Preparation of Sample 105—

The aqueous dispersion of Sample 105 was prepared in the same manner as in the preparation of Sample 101 except that the heating was performed at a pressure of 1.8 atm, at 120° C. for 8 hours.

The silver nanowires in the obtained Sample 105 had a short axis whose length was 25 nm to 30 nm and a long axis whose length was 40 μm to 50 μm.

Water was added to each of the aqueous dispersions obtained, and each mixture was centrifuged and purified such that the conductivity was 50 μS/cm or less, followed by adjustment of the silver content to 22% by mass, whereby an aqueous dispersion for coating was prepared. The viscosities of all these aqueous dispersions for coating were within 10 mPa·s or less at 250C. With an XRD apparatus (RINT2500, produced by Rigaku Corporation), the diffraction pattern of metallic silver for each sample was obtained.

Next, a commercially available thermofixed biaxial extension polyethylene terephthalate (PET) substate having a thickness of 100 μm after dried was treated with corona discharge of 8 W/m²·min, and an undercoat layer having the following formulation was coated such that the thickness thereof after dried was 0.8 μm.

### —Formulation of the Undercoat Layer—

The undercoat layer contains a copolymer latex containing butylacrylate (40% by mass), styrene (20% by mass), and glycidylacrylate (40% by mass); and hexamethylene-1,6-bis(ethyleneurea) (0.5% by mass).

Next, the surface of the undercoat layer was subjected to a corona discharge treatment of 8 W/m²·min, and hydroxyethylcellulose was coated as a hydrophilic polymer layer on the undercoat layer such that the thickness after dried was 0.2 μm.

Then, using a doctor coater, each of the aqueous dispersions of Samples 101-105 for coating was coated on the hydrophilic polymer layer, and the coated layer was dried. The coating amount of silver was adjusted to 0.02 g/m² by measuring the amount with a fluorescent X-ray analyzer (SEA1100, produced by Seiko Instruments, Inc.).

The properties of the coated products were evaluated. Results are shown in Table 1.

### <Transmittance of the Coated Product>

The transmittance of 400 nm to 800 nm was measured with UV-2550 (produced by Shimadzu Corporation).

### <Surface Resistance of the Coated Product>

The surface resistance was measured with LORESTA-GP MCP-T600 (produced by Mitsubishi Chemical Corporation).

After stirring with a magnetic stirrer, the aqueous dispersion was moved into a transparent acryl cylinder having 5 cm side and 30 cm height, and was then allowed to stand for 3 hours. A liquid at a depth of 2 cm from the surface of water was drawn up as a sample, and the ultraviolet transmission absorption spectrum of the sample was measured by UV-2550 (produced by Shimadzu Corporation) and dispersion stability was evaluated. As a baseline, a dispersion stability of a water-filled optical cell was defined as 100%. A sample having a high dispersion stability was low in transmittance even near the surface of water, and a sample having a low dispersion stability was high in transmittance near the surface of water because of marked sedimentation.

Evaluation criteria were as follows. The dispersion stability increases with the increase of the number.

### [Evaluation Criteria]

1: Transmittance is 90% or higher, sedimentation occurs markedly, and the sample is problematic level in practical terms.

2. Transmittance is 70% or higher and lower than 90%, sedimentation is recognizable, and the sample is problematic level in practical terms.

3. Transmittance is 50% or higher and lower than 70%, slight sedimentation can be seen, the sample has no problem level in practical terms.

4. Transmittance is 30% or higher and lower than 50%, little sedimentation can be seen, the sample has no problem level in practical terms.

5. Transmittance is 0% or higher and lower than 30%, no sedimentation can be seen, the sample has no problem level in practical terms.

TABLE 1

| | | Surface | | |
|---|---|---|---|---|
| | | Resistance | Dispersion | |
| Sample No. | Transmittance (%) | (Ω/cm²) | Stability | |
| 101 | 85 | 95 | 5 | Example |
| 102 | 82 | 110 | 5 | Example |
| 103 | 75 | 100 | 3 | Example |
| 104 | 81 | 90 | 4 | Example |
| 105 | 65 | 8,500 | 2 | Comparative |
| | | | | Example |

The silver nanowires and the aqueous dispersion of the present invention has broad uses, including a touch panel, an antistatic treatment for a display, an electromagnetic interference sealed material, an electrode or antistatic agent for an organic or inorganic EL display, an electrode for a solar cell, and electronic paper.

What is claimed is:

1. A method for producing a silver nanowire comprising heating a silver complex in a water solvent at a temperature equal to or below the boiling point of the water solvent.

2. The method for producing a silver nanowire according to claim 1, wherein the silver complex is a complex of ammonical silver.

3. The method for producing a silver nanowire according to claim 1, wherein the silver nanowire is produced through a silver halide.

4. The method for producing a silver nanowire according to claim 1, wherein a reducing agent is added when heating the silver complex.

5. The method for producing a silver nanowire according to claim 4, wherein the reducing agent is a reducing sugar.

6. A silver nanowire obtainable by a method for producing a silver nanowire, wherein the method comprises heating a silver complex in a water solvent at a temperature equal to or below the boiling point of the water solvent.

7. The silver nanowire according to claim 6, having a short axis of 5 nm to 500 nm in length.

8. An aqueous dispersion comprising:
a silver nanowire,
wherein the silver nanowire is obtainable by a method for producing a silver nanowire, and wherein the method comprises heating a silver complex in a water solvent at a temperature equal to or below the boiling point of the water solvent.

9. A transparent conductor comprising:
a transparent conductive layer,
wherein the transparent conductive layer is formed with an aqueous dispersion containing a silver nanowire, and
wherein the silver nanowire is obtainable by a method for producing a silver nanowire, and the method comprises heating a silver complex in a water solvent at a temperature equal to or below the boiling point of the water solvent.
